(19) United States
(12) Patent Application Publication
(10) Pub. No.: US 2026/0152227 A1
(43) Pub. Date: Jun. 4, 2026

(54) METHOD TO MANAGE DYNAMIC VARIABLE RATIO AND MISALIGNMENT IN STEER-BY-WIRE SYSTEMS

(71) Applicant: Steering Solutions IP Holding Corporation, Saginaw, MI (US)

(72) Inventor: Joel E. Birsching, Vassar, MI (US)

(21) Appl. No.: 19/394,276

(22) Filed: Nov. 19, 2025

Related U.S. Application Data
(60) Provisional application No. 63/727,310, filed on Dec. 3, 2024.

(51) Int. Cl. B62D 6/00

(52) U.S. Cl. CPC B62D 6/003

(57) ABSTRACT

A method for obtaining a blended target rack position curve includes, using one or more processors, calculating a first target rack position curve based on a first vehicle speed, controlling a rack position based on the first target rack position curve when travelling at the first vehicle speed, in response to a change in handwheel position and a transition to a second vehicle speed, calculating the blended target rack position curve using both the first target rack position curve and an offset factor corresponding to the second vehicle speed, and controlling the rack position based on the blended target rack position curve.

### CROSS-REFERENCE TO RELATED APPLICATIONS

This application claims the benefit of U.S. Provisional Application No. 63/727,310, filed on Dec. 3, 2024. The entire disclosure of the application referenced above is incorporated herein by reference.

### TECHNICAL FIELD

This disclosure relates to steer-by-wire (SbW) systems.

### BACKGROUND OF THE INVENTION

A vehicle, such as a car, truck, sport utility vehicle, crossover, mini-van, marine craft, aircraft, all-terrain vehicle, recreational vehicle, or other suitable forms of transportation, typically includes a steering system, such as an electronic power steering (EPS) system, a steer-by-wire (SbW) steering system, a hydraulic steering system, or other suitable steering system. The steering system of such a vehicle typically controls various aspects of vehicle steering including providing steering assist to an operator of the vehicle, controlling steerable wheels of the vehicle, and the like.

### SUMMARY OF THE INVENTION

A method for obtaining a blended target rack position curve includes, using one or more processors, calculating a first target rack position curve based on a first vehicle speed, controlling a rack position based on the first target rack position curve when travelling at the first vehicle speed, in response to a change in handwheel position and a transition to a second vehicle speed, calculating the blended target rack position curve using both the first target rack position curve and an offset factor corresponding to the second vehicle speed, and controlling the rack position based on the blended target rack position curve.

In other features, one or more systems are configured to perform steps or functions of the methods described herein.

In other features, one or more controllers, computing devices, processors, processing devices, etc. are configured to perform steps or functions of the methods described herein. For example, one or more processors are configured to execute instructions stored in memory to perform the methods described herein.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1A generally illustrates a vehicle according to the principles of the present disclosure.

FIG. 1B generally illustrates a controller according to the principles of the present disclosure.

FIG. 2 generally illustrates an example rack or RWA controller and column or handwheel actuator (HWA) of a steering system according to the principles of the present disclosure.

FIG. 3 generally illustrates an example of two different rack position target curves as a function of handwheel angle for two different vehicle speeds according to the principles of the present disclosure.

FIG. 4 generally illustrates an example blended rack position target according to the principles of the present disclosure.

FIG. 5 generally illustrates an example of a (delta) ΔC-factor according to the principles of the present disclosure.

FIG. 6 generally illustrates steps of an example method for implementing techniques for transitioning between target rack position curves according to the principles of the present disclosure.

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, a vehicle, such as a car, truck, sport utility vehicle, crossover, mini-van, marine craft, aircraft, all-terrain vehicle, recreational vehicle, or other suitable forms of transportation, typically includes a steering system, such as an electronic power steering (EPS) system, a steer-by-wire (SbW) steering system, a hydraulic steering system, or other suitable steering system. The steering system of such a vehicle typically controls various aspects of vehicle steering including providing steering assist to an operator of the vehicle, controlling steerable wheels of the vehicle, and the like.

SbW steering systems eliminate the mechanical connection between the handwheel (i.e., steering wheel) and the road wheels. Instead, SbW steering systems use a handwheel position sensor to sense movement of the handwheel by the driver in order to determine the desired rack and road wheel position. The elimination of the mechanical connection between the handwheel and the road wheels allows a C-factor or steering ratio to be changed dynamically, which can be done for different modes of operation, as well as a function of other variables such as vehicle speed. Generally, the C-factor defines a relationship between rotation of the handwheel and linear movement of the steering rack (e.g., expressed as linear distance traveled per revolution of a pinion gear).

In some examples, if vehicle speed changes while the handwheel angle is not at zero degrees, the rack position target changes, which can result an undesirable/unintended change in lateral motion of the vehicle when the driver is not changing handwheel position. This unintended change in lateral motion can be minimized by applying slew rates, filters, etc. An alternative approach is to fix the rack position target curve when the driver steers away from center (i.e., handwheel angle of 0), and then change the target curve when the driver crosses back through center.

An additional aspect of elimination of the mechanical connection between the handwheel and the road wheels is that the handwheel and the road wheels can become misaligned. When misaligned, actual handwheel and rack position do not follow the path as specified by the rack position target (e.g. as represented by a target rack position curve). In this situation, the system needs to employ a method to transition the handwheel and road wheels back into alignment with the target rack position curve.

Systems and methods of the present disclosure implement techniques for transitioning between target rack position curves in a manner that not only matches target rack position while passing through center but also matches the slope (or C-factor) when passing through center. These systems and methods address both ratio/target position curve changes and misalignments.

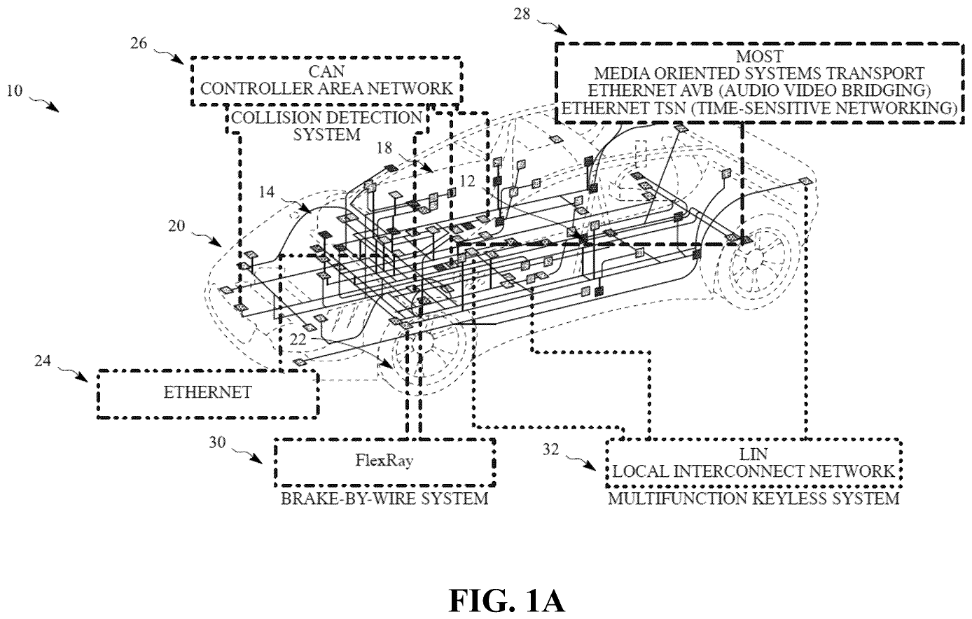

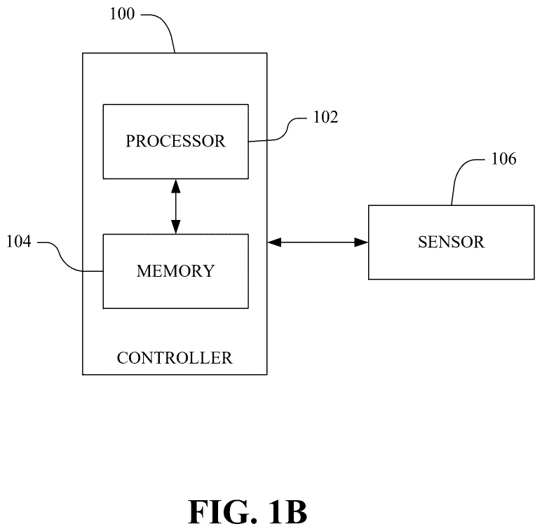

FIG. 1A generally illustrates a vehicle 10 according to the principles of the present disclosure. The vehicle 10 may include any suitable vehicle, such as a car, a truck, a sport utility vehicle, a minivan, a crossover, any other passenger vehicle, any suitable commercial vehicle, or any other suitable vehicle. While the vehicle 10 is illustrated as a passenger vehicle having wheels and for use on roads, the principles of the present disclosure may apply to other vehicles, such as planes, boats, trains, drones, or other suitable vehicles.

The vehicle 10 includes a vehicle body 12 and a hood 14. A passenger compartment 18 is at least partially defined by the vehicle body 12. Another portion of the vehicle body 12 defines an engine compartment 20. The hood 14 may be moveably attached to a portion of the vehicle body 12, such that the hood 14 provides access to the engine compartment 20 when the hood 14 is in a first or open position and the hood 14 covers the engine compartment 20 when the hood 14 is in a second or closed position. In some embodiments, the engine compartment 20 may be disposed on rearward portion of the vehicle 10 than is generally illustrated.

The passenger compartment 18 may be disposed rearward of the engine compartment 20, but may be disposed forward of the engine compartment 20 in embodiments where the engine compartment 20 is disposed on the rearward portion of the vehicle 10. The vehicle 10 may include any suitable propulsion system including an internal combustion engine, one or more electric motors (e.g., an electric vehicle), one or more fuel cells, a hybrid (e.g., a hybrid vehicle) propulsion system comprising a combination of an internal combustion engine, one or more electric motors, and/or any other suitable propulsion system.

In some embodiments, the vehicle 10 may include a petrol or gasoline fuel engine, such as a spark ignition engine. In some embodiments, the vehicle 10 may include a diesel fuel engine, such as a compression ignition engine. The engine compartment 20 houses and/or encloses at least some components of the propulsion system of the vehicle 10. Additionally, or alternatively, propulsion controls, such as an accelerator actuator (e.g., an accelerator pedal), a brake actuator (e.g., a brake pedal), a handwheel, and other such components are disposed in the passenger compartment 18 of the vehicle 10. The propulsion controls may be actuated or controlled by an operator of the vehicle 10 and may be directly connected to corresponding components of the propulsion system, such as a throttle, a brake, a vehicle axle, a vehicle transmission, and the like, respectively. In some embodiments, the propulsion controls may communicate signals to a vehicle computer (e.g., drive by wire) which in turn may control the corresponding propulsion component of the propulsion system. As such, in some embodiments, the vehicle 10 may be an autonomous vehicle.

In some embodiments, the vehicle 10 includes a transmission in communication with a crankshaft via a flywheel or clutch or fluid coupling. In some embodiments, the transmission includes a manual transmission. In some embodiments, the transmission includes an automatic transmission. The vehicle 10 may include one or more pistons, in the case of an internal combustion engine or a hybrid vehicle, which cooperatively operate with the crankshaft to generate force, which is translated through the transmission to one or more axles, which turns wheels 22. When the vehicle 10 includes one or more electric motors, a vehicle battery, and/or fuel cell provides energy to the electric motors to turn the wheels 22.

The vehicle 10 may include automatic vehicle propulsion systems, such as a cruise control, an adaptive cruise control, automatic braking control, other automatic vehicle propulsion systems, or a combination thereof. The vehicle 10 may be an autonomous or semiautonomous vehicle, or other suitable type of vehicle. The vehicle 10 may include additional or fewer features than those generally illustrated and/or disclosed herein.

In some embodiments, the vehicle 10 may include an Ethernet component 24, a controller area network (CAN) bus 26, a media-oriented systems transport component (MOST) 28, a FlexRay component 30 (e.g., brake-by-wire system, and the like), and a local interconnect network component (LIN) 32. The vehicle 10 may use the CAN bus 26, the MOST 28, the FlexRay component 30, the LIN 32, other suitable networks or communication systems, or a combination thereof to communicate various information from, for example, sensors within or external to the vehicle, to, for example, various processors or controllers within or external to the vehicle. The vehicle 10 may include additional or fewer features than those generally illustrated and/or disclosed herein.

In some embodiments, the vehicle 10 may include a steering system, such as an EPS system, a steering-by-wire steering system (e.g., which may include or communicate with one or more controllers that control components of the steering system without the use of mechanical connection between the handwheel and wheels 22 of the vehicle 10), a hydraulic steering system (e.g., which may include a magnetic actuator incorporated into a valve assembly of the hydraulic steering system), or other suitable steering system.

The steering system may include an open-loop feedback control system or mechanism, a closed-loop feedback control system or mechanism, or combination thereof. The steering system may be configured to receive various inputs, including, but not limited to, a handwheel position, an input torque, one or more road wheel positions, other suitable inputs or information, or a combination thereof.

Additionally, or alternatively, the inputs may include a handwheel torque, a handwheel angle, a motor velocity, a vehicle speed, an estimated motor torque command, other suitable input, or a combination thereof. The steering system may be configured to provide steering function and/or control to the vehicle 10. For example, the steering system may generate an assist torque based on the various inputs. The steering system may be configured to selectively control a motor of the steering system using the assist torque to provide steering assist to the operator of the vehicle 10.

In some embodiments, the vehicle 10 includes one or more controllers, such as controller 100, as is generally illustrated in FIG. 1B. The controller 100 may correspond to a steering system controller. The controller 100 may include any suitable controller, such as an electronic control unit or other suitable controller. The controller 100 may be configured to control, for example, the various functions of the steering system and/or various functions of the vehicle 10. The controller 100 may include a processor 102 and a memory 104. The processor 102 may include any suitable processor, such as those described herein. Additionally, or alternatively, the controller 100 may include any suitable number of processors, in addition to or other than the processor 102. The memory 104 may comprise a single disk or a plurality of disks (e.g., hard drives), and includes a storage management module that manages one or more partitions within the memory 104. In some embodiments, memory 104 may include flash memory, semiconductor (solid state) memory or the like. The memory 104 may include Random Access Memory (RAM), a Read-Only Memory (ROM), or a combination thereof. The memory 104 may include instructions that, when executed by the processor 102, cause the processor 102 to, at least, control various aspects of the vehicle 10. Additionally, or alternatively, the memory 104 may include instructions that, when executed by the processor 102, cause the processor 102 to perform functions associated with the systems and methods described herein.

The controller 100 may receive one or more signals from various measurement devices or sensors 106 indicating sensed or measured characteristics of the vehicle 10. The sensors 106 may include any suitable sensors, measurement devices, and/or other suitable mechanisms. For example, the sensors 106 may include one or more torque sensors or devices, one or more handwheel position sensors or devices, one or more motor position sensor or devices, one or more position sensors or devices, other suitable sensors or devices, or a combination thereof. The one or more signals may indicate a handwheel torque, a handwheel angle, a motor velocity, a vehicle speed, other suitable information, or a combination thereof.

As used herein, “controller” may refer to a hardware module or assembly including one or more processors or microcontrollers, memory, sensors, one or more actuators, a communication interface, etc., any portions of which may be collectively referred to as “circuitry.” As described herein, respective functions and steps performed by a given controller, control circuitry, etc. may be collectively performed by multiple controllers, processors, etc. For example, a processor, processing device, controller, control circuitry, etc. “configured to perform” may refer to a single processor, processing device, controller, etc. configured to perform both A and B or may refer to a first processor, processing device, controller, etc. configured to perform A and a second processor, processing device, controller, etc. configured to perform B. For simplicity, “control circuitry configured to perform A and B” may refer to a single or multiple processors, processing devices, controllers, etc. collectively configured to perform A and B.

In some embodiments, the controller 100 may perform the functions of the systems and methods described herein. However, the functions described herein as performed by the controller 100 are not meant to be limiting, and any type of software executed on a controller, processor, or other circuitry can implement the techniques described herein without departing from the scope of this disclosure. For example, a controller, such as a processor executing software within a computing device, can implement the systems and methods described herein.

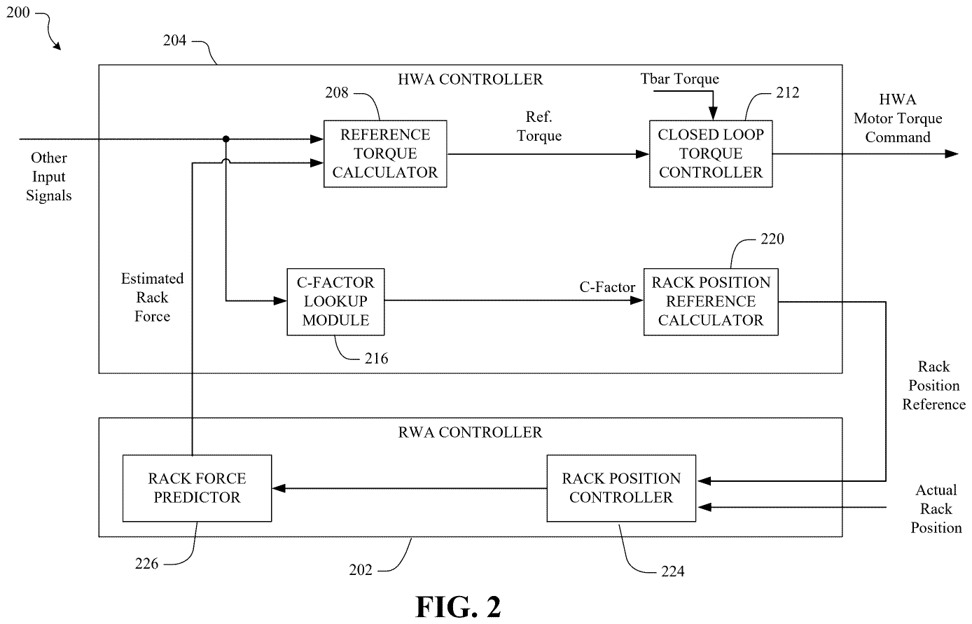

FIG. 2 illustrates an example steering system 200 including a rack or RWA controller 202 and column or handwheel actuator (HWA) controller 204 of a steering system configured to implement techniques according to the present disclosure. For example, the HWA controller 204 is configured to generate a handwheel actuator (HWA) motor torque command based on an estimated rack force (e.g., an estimated rack force signal) received from the RWA controller 202 and one or more other input signals (e.g., vehicle speed, handwheel position, and handwheel velocity). The RWA controller 202 is configured to determine the estimated rack force based on the motor torque required to achieve or maintain an actual rack position. The controllers 200 and 204 may correspond to, be implemented by, etc. one or more steering system controllers.

As one example, the HWA controller 204 includes a reference torque calculator 208 configured to calculate a reference torque (T_{ref}) based on the estimated rack force and the one or more other input signals. For example, the reference torque corresponds to a sum of various inputs/measurements such as effort, hysteresis, return correction or CVR, damping, catch, etc. A closed loop (e.g., a PID closed loop) torque controller 212 is configured to generate and output the motor torque command based at least in part on a force or torque applied by the driver (e.g., “Tbar torque”) and the reference torque. The motor torque command is provided as a control signal to control a motor of the handwheel actuator.

The estimated rack force corresponds to the measured or estimated road wheel actuator motor torque. Accordingly, the estimated rack force (and any estimated rack force offset or error) is a critical factor for determining the force provided by the motor of the handwheel actuator.

In some examples, the HWA controller 204 may further include a C-factor lookup module 216 and a rack position reference calculator 220. Although shown as being implemented in the HWA controller 204, one or more of C-factor lookup and rack position reference calculation can instead be implemented by the RWA controller 202. For example, the rack position reference calculator 220 is configured to generate the rack position reference based on a C-factor received from the C-factor lookup module 216. The C-factor may be determined based on a handwheel angle (“HwAg”) corresponding to driver input (e.g., a handwheel angle indicating driver intent conveyed via the handwheel). Example systems and methods for obtaining the rack position reference and the C-factor are described in more detail in U.S. patent application Ser. No. 18/318,657, filed on May 16, 2023, the entire contents of which are incorporated herein by reference.

The RWA controller 202 includes a rack position controller 224 (e.g., a PID rack position controller) configured to generate one or more rack position control signals based on the actual rack position and the rack position reference (e.g., based on a difference between the actual rack position and the rack position reference). For example, the rack position control signals may include, but are not limited to, rack motor velocity and motor torque command (e.g., indicative of an amount of torque applied by the driver) signals. In this manner, rack position is controlled to follow the intent of the driver (as indicated by the rack reference position).

A rack force predictor 226 generates the estimated rack force based on outputs of the rack position controller 224 (e.g., based on a function of the rack motor velocity, the rack motor torque command, etc.). In various examples, the estimated rack force may be calculated based on the amount of torque applied to the handwheel by the driver (as indicated by the rack motor torque command, various sensor signals, etc.). As shown, the rack force predictor 226 may output the estimated rack force and the reference torque calculator 208 (and/or another component of the RWA controller 202, the HWA controller 204, etc.) may obtain an estimated rack load based on the estimated rack force. In other examples, the rack force predictor 226 may output the estimated rack load. In some contexts, the terms “estimated rack force” and “estimated rack load” may be used interchangeably.

For example, for RWA position control, the rack position reference signal (“RackPosRef”) may be calculated based on a position error (“PosErr”) between an ADAS rack position reference value or signal (“ADASRackPosRef”) and an HWA rack position reference value or signal (“HWARackPosRef”). Conversely, HWA position control is based on a position error between the HWA position and the RWA position, such that the handwheel can be controlled to rotate in a manner consistent with rotation of the road wheel in hands-off conditions.

The reference torque may correspond to a desired, ideal, or target torque to be felt by the driver (i.e., at the handwheel/steering wheel). As described above, the reference torque is calculated based on inputs including, but not limited to, driver input (e.g., an input torque, corresponding to steering handwheel angle), road conditions, damping, hysteresis, etc. A torque at the handwheel is controlled (e.g., via the HWA) to match the reference torque. For example, outputs of one or more sensors measuring actual torque at the wheel are used to minimize the difference between the reference torque and the actual torque.

An effort function (e.g., an effort function implemented by the reference torque calculator 208) defines a relationship between driver input (e.g., the force or torque applied by the driver to the handwheel, which may be referred to as “effort”) and a response (i.e., movement) of the steering system. For example, the effort function may output an effort value based on a lookup table or other function (e.g., by using an estimated rack load as an input). The estimated rack load may be modified prior to being input to the lookup table by adding a calculated return load value to the estimated rack load. The effort function indicates an amount of effort required by the driver to cause a desired response.

The steering system 200 according to the present disclosure is configured to implement techniques for transitioning between target rack position curves in a manner that not only matches target rack position while passing through center but also matches the slope (or C-factor) when passing through center as described below in more detail.

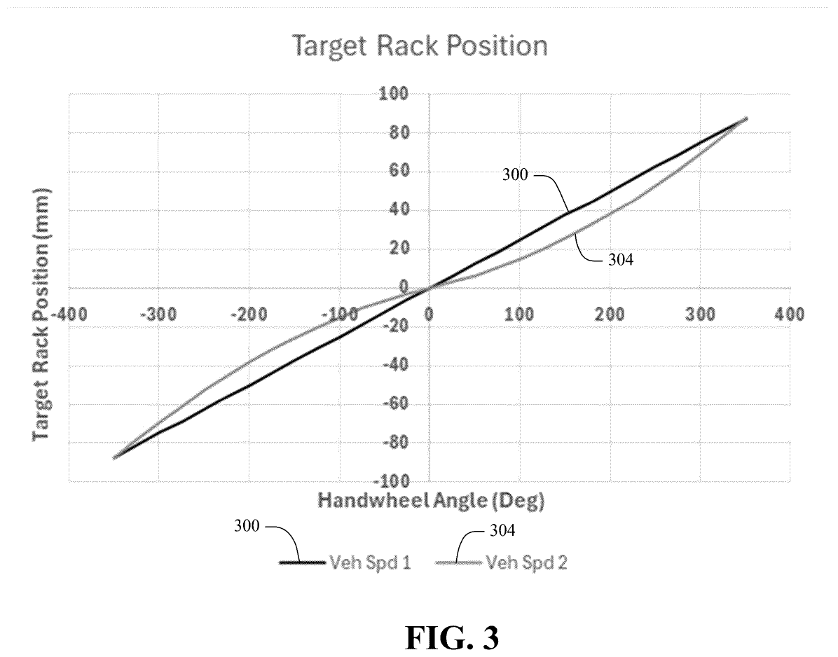

FIG. 3 shows an example of two different rack position target curves 300 and 304 as a function of handwheel angle for two different vehicle speeds. The curves 300, 304 can be generated by a lookup table (LUT) or other methods (e.g., a function or algorithm, model, etc.). As shown, if vehicle speed changes while the handwheel angle is not at zero degrees (e.g., from a first vehicle speed, corresponding to 300, to a second vehicle speed, corresponding to 304), the rack position target changes, which can result an undesirable/unintended change in lateral motion of the vehicle when the driver is not changing handwheel position. This unintended change in lateral motion can be minimized by applying slew rates, filters, etc.

An alternative approach is to fix the rack position target curve when the driver steers away from center (i.e., handwheel angle of 0), and then change the target curve when the driver crosses back through center. With this approach, target rack position follows the curve 300 in one direction and switches to the curve 304 when passing through center (i.e., a handwheel angle of 0). While the target position is the same for both curves at center, there is an immediate change in the slope of the curve (i.e., the slope of the curve 300 relative to the slope of the curve 304) which results in undesirable steering feel.

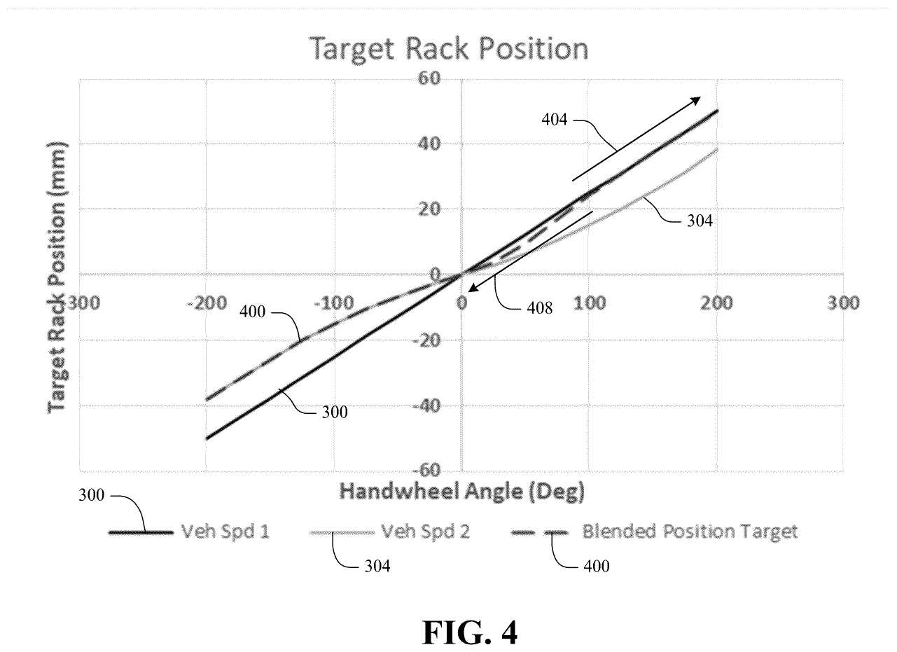

FIG. 4 shows an example blended rack position target (a blended or combined rack position target curve 400, shown as a dashed line, corresponding to a combination of the curves 300 and 304) according to the principles of the present disclosure. In an example where the driver initiates a turn when the vehicle is traveling at a first vehicle speed (e.g., a speed associated with the curve 300) and the vehicle speed increases to a second vehicle speed while turning (e.g., increases to the vehicle speed associated with the curve 304), the rack position target follows the curve 300 when steering away from center (e.g., in a handwheel angle direction/region shown at 404). However, in accordance with the principles of the present disclosure, the rack position target returns back and though center on the curve 400 (e.g., in a handwheel angle direction/region shown at 408). The curve 400 corresponds to a blended position (a combination of the curves 300 and 304). Accordingly, as shown, the curve 400 matches the curve 304 both in slope and position when the driver crosses back through center (i.e., across the center axis of FIG. 4). In this manner, an abrupt change in slope (and steering feel) caused by a change from the curve 300 to the curve 304 when crossing through center is avoided.

Using the blending techniques of the present disclosure, the target rack position (X), corresponding to the curve 400, is determined by fixing the target curve at a point where the driver steers away from center (a “fixed curve position”) and adding an offset (Δx) to the target rack position X as shown below:

X=LUT(θ)+Δx(θ),

Where LUT(θ) is determined at the fixed curve position and Δx(θ) is determined for an operating condition that determines the target rack position curve, such as vehicle speed. For example, Δx(θ), which may be referred to as an offset or adjustment factor, may be determined based on an actual vehicle speed (rather than the vehicle speed that resulted in the use of the curve 300), which may be the same as or different from the vehicle speed corresponding to the curve 304. Accordingly, as the driver crosses back toward center (in the direction 408 as shown in FIG. 4), the curve 400 begins to deviate from the curve 300 in an amount corresponding to Δx(θ) (e.g., based at least in part on vehicle speed) as the driver approaches center. In this manner, when the driver reaches the center position, the curve 400 matches the curve 304 in slope and position.

To ensure that the slope of a target curve approaching a position (e.g., the curve 400 as the driver returns toward center in the direction 408) and leaving the position (e.g., the curve 304) always match, a limit is placed on how much the C-factor can change as a function of position. This is used to produce a ΔC-factor curve. In order to match the slope when crossing through center, the C-factor (e.g., a C-factor at a handwheel angle of “0” position, or an “on-center C-factor) is determined at the fixed target speed (CF0 fxd) and at the actual speed (CF0). The difference between these two values is the desired ΔC-factor when crossing through zero. Using these two values, a desired ΔC-factor curve can be determined by matching the C-factor at the current angle and at zero. To ensure that the target rack position curve crosses through zero, the integration of the curve (i.e., the area under the curve) is zero. Meeting all these conditions allows a ΔC-factor curve to be established that matches both position and slope when crossing through center.

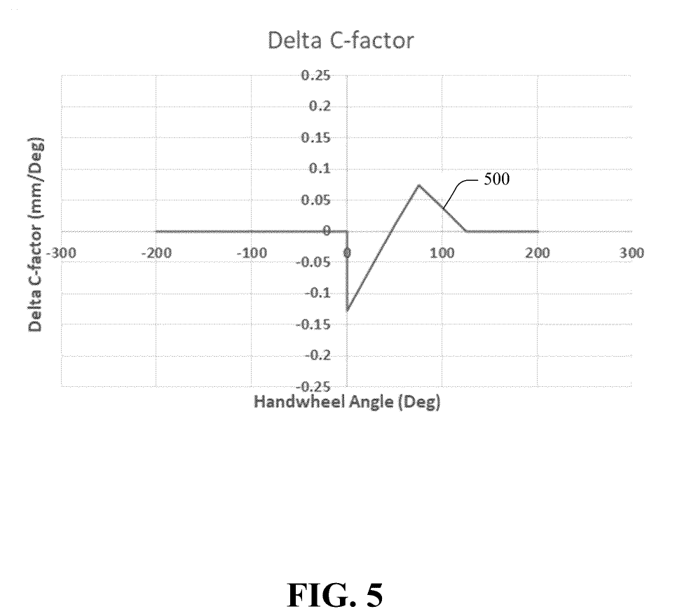

FIG. 5 shows an example of a (delta) ΔC-factor 500 according to the principles of the present disclosure. As shown, the ΔC-factor 500 curve is comprised of linear segments, but any group of functions or segments can be used to construct the curve. In this example, the driver is operating on the first vehicle speed target rack position curve 300 when steering away from center as shown in FIG. 4. When the driver steers back toward center, the delta C-factor 500 is applied, and the rack position offset (Δx) is added to the rack position target. When the driver steers through zero, the target rack position curve switches to the second vehicle speed target rack position curve 304. At this point, CF0 fxd and CF0 are the same, so the ΔC-factor is zero.

If the driver steers away from center, then steers back toward center, initiating the ΔC-factor 500 curve, and once again steers away from center, the ΔC-factor 500 curve will be followed until the fixed target rack position curve is reached.

Using this approach, at least a Min C-factor, Max C-factor, and Max ΔC-factor/deg calibrations are used to limit the ΔC-factor curve. In an example, a Min ΔC-factor and a Max ΔC-factor are determined using the Min C-factor, the Max C-factor, and the Max ΔC-factor/deg calibrations. These calibrations may be a function of vehicle speed and/or other variables. These limits may prevent the generation of a ΔC-factor curve that matches both slope and position when crossing through zero, or in matching the fixed target rack position when steering away from center. For these conditions, priority can be set to either match the slope or the position. For example, when crossing through center, the priority can be set to cross through the zero point with as close of a slope as allowed by the ΔC-factor limits. In the same manner, the priority can be to match the slope when steering away from center even though the position is not matched. If the position is not matched in these conditions, the result is a misalignment. This misalignment is reduced and eliminated as the system is steered back through center using the ΔC-factor 500 curve. If the amount of misalignment exceeds the ΔC-factor limits, multiple passes through center may be required to completely eliminate the misalignment.

The rack position offset (Δx) is described herein as a function of handwheel angle(θ). However, these techniques can also be used to determine a handwheel angle offset (Δθ) as a function of rack position (x). In another example, the target rack position (X) can be determined according to:

X=LUT(θ+Δθ).

In this example, the inverse C-factors at zero (1/CF0) and (1/CF0fxd) are used to create a required Δ inverse C-factor curve. The integration of the A inverse C-factor curve provides a Δθ value. In various examples described herein, the offset or adjustment (e.g., Δx(θ), Δθ, etc.) to the rack position curve can be referred to as an offset or adjustment factor, which can be determined in accordance with the ΔC-factor as described above.

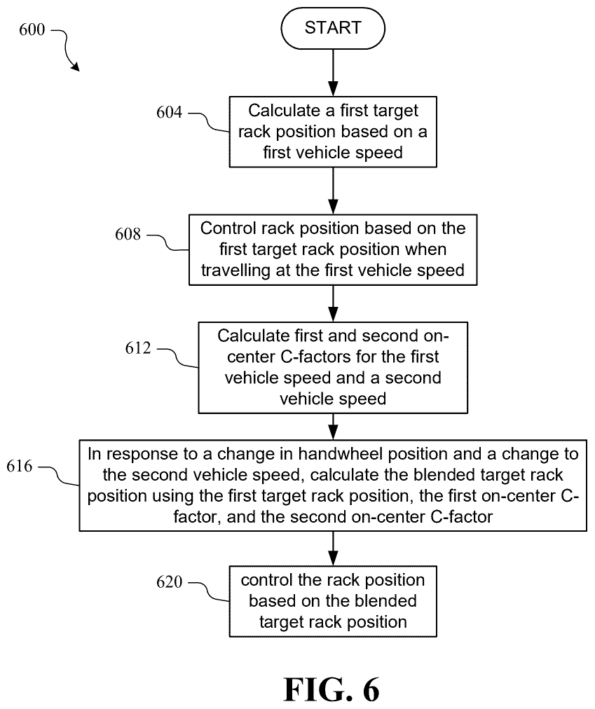

FIG. 6 generally illustrates steps of an example method 600 for implementing techniques for transitioning between target rack position curves according to the principles of the present disclosure. Steps of the method 600 may be implemented by systems and components described herein, such as the controller 100, the system 200, one or more computing devices, processors, or processing devices (e.g., one or more processing devices configured to execute instructions stored in memory), etc.

At 604, the method 600 includes calculating a first target rack position based on a first vehicle speed. At 608, the method 600 includes controlling a rack position based on the first target rack position when travelling at the first vehicle speed. At 612, the method 600 includes calculating an on-center C-factor for the first vehicle speed (a first on-center C-factor) and for a second vehicle speed (a second on-center C-factor). At 616, the method 600 includes, in response to a change in handwheel position and a change (i.e., a transition to) to the second vehicle speed, calculating the blended target rack position using the first target rack position, the first on-center C-factor, and the second on-center C-factor. At 620, the method 600 includes controlling the rack position based on the blended target rack position.

Accordingly, as described herein, the systems and methods of the present disclosure implement techniques for: managing dynamic variable ratio to match C-factor and position when handwheel position crosses through zero degrees; using a delta C-factor to generate rack position offset; using a rack position offset to transition between target rack position curves; using a delta C-factor curve to correct misalignment; using a delta inverse C-factor to generate a handwheel angle offset; using a handwheel angle offset to transition between target rack position curves; and using a delta inverse C-factor curve to correct misalignment.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably. As used herein, the terms “approximate” or “approximately” may correspond to within +/−5% of a value, variable, etc.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. A method for obtaining a blended target rack position curve, the method comprising, using one or more processors:
calculating a first target rack position curve based on a first vehicle speed;
controlling a rack position based on the first target rack position curve when travelling at the first vehicle speed;
in response to a change in handwheel position and a transition to a second vehicle speed, calculating the blended target rack position curve using both the first target rack position curve and an offset factor corresponding to the second vehicle speed; and
controlling the rack position based on the blended target rack position curve.

2. The method of claim 1, wherein calculating the blended target rack position curve includes calculating the offset factor based on a C-factor.

3. The method of claim 2, wherein calculating the offset factor based on a C-factor includes calculating the offset factor based on at least one on-center C-factor.

4. The method of claim 1, further comprising:
controlling the rack position based on the first target rack position curve when travelling at the first vehicle speed and in response to the handwheel position moving in a first direction; and
in response to the handwheel position moving in a second direction, controlling the rack position based on the blended target rack position curve.

5. The method of claim 1, wherein the blended target rack position curve is between the first target rack position curve and a second target rack position curve.

6. The method of claim 5, wherein the blended target rack position is calculated such that a first slope of the blended target rack position curve is approximately equal to a second slope of the second target rack position curve at a handwheel angle of 0.

7. The method of claim 1, further comprising calculating the blended target rack position curve in accordance with X=LUT(0)+Δx(θ), where X is the blended target rack position curve, LUT(θ) corresponds to the first target rack position curve, and Δx(θ) is the offset factor.

8. The method of claim 7, wherein LUT(θ) corresponds to the first target rack position curve at a handwheel angle θ.

9. A processor configured to executed instructions stored in memory, wherein executing the instructions causes the processor to obtain a blended target rack position curve by:
calculating a first target rack position curve based on a first vehicle speed;
controlling a rack position based on the first target rack position curve when travelling at the first vehicle speed;
in response to a change in handwheel position and a transition to a second vehicle speed, calculating the blended target rack position curve using both the first target rack position curve and an offset factor corresponding to the second vehicle speed; and
controlling the rack position based on the blended target rack position curve.

10. The processor of claim 9, wherein calculating the blended target rack position curve includes calculating the offset factor based on a C-factor.

11. The processor of claim 10, wherein calculating the offset factor based on a C-factor includes calculating the offset factor based on at least one on-center C-factor.

12. The processor of claim 9, wherein executing the instructions further causes the processor to:
control the rack position based on the first target rack position curve when travelling at the first vehicle speed and in response to the handwheel position moving in a first direction; and
in response to the handwheel position moving in a second direction, control the rack position based on the blended target rack position curve.

13. The processor of claim 9, wherein the blended target rack position curve is between the first target rack position curve and a second target rack position curve.

14. The processor of claim 9, wherein the blended target rack position is calculated such that a first slope of the blended target rack position curve is approximately equal to a second slope of the second target rack position curve at a handwheel angle of 0.

15. The processor of claim 9, wherein executing the instructions further causes the processor to calculate the blended target rack position curve in accordance with X=LUT(θ)+Δx(θ), where X is the blended target rack position curve, LUT(θ) corresponds to the first target rack position, and Δx(θ) is the offset factor.

16. The processor of claim 15, wherein LUT(θ) corresponds to the first target rack position curve at a handwheel angle θ.

17. A system, comprising:
one or more sensors configured to generate signals corresponding to operating characteristics of a vehicle; and
a controller configured to receive the signals and, based on the signals
calculate a first target rack position curve based on a first vehicle speed;
control a rack position based on the first target rack position curve when travelling at the first vehicle speed;
in response to a change in handwheel position and a transition to a second vehicle speed, calculate the blended target rack position curve using both the first target rack position curve and an offset factor corresponding to the second vehicle speed; and
control the rack position based on the blended target rack position curve.

18. The system of claim 17, wherein the controller is further configured to:
control the rack position based on the first target rack position curve when travelling at the first vehicle speed and in response to the handwheel position moving in a first direction, and
in response to the handwheel position moving in a second direction, controlling the rack position based on the blended target rack position curve.

19. The system of claim 17, wherein the blended target rack position curve is calculated such that a first slope of the blended target rack position curve is approximately equal to a second slope of the second target rack position curve at a handwheel angle of 0.

20. A vehicle comprising the system of claim 17.
